(19) United States
(12) Patent Application Publication
(10) Pub. No.: US 2023/0232813 A1
(43) Pub. Date: Jul. 27, 2023

(54) SOIL HEATING APPARATUS FOR MODULAR GANTRY FARMING EQUIPMENT

(71) Applicant: Agbotic Incorporated, Sackets Harbor, NY (US)

(72) Inventors: John Gaus, Watertown, NY (US); Cody Morse, Redfield, NY (US); Logan Hosely, Rodman, NY (US)

(73) Assignee: Agbotic Incorporated, Sackets Harbor, NY (US)

(21) Appl. No.: 18/011,775

(22) PCT Filed: Jun. 24, 2021
(86) PCT No.: PCT/US2021/038855

§ 371 Date: Dec. 20, 2022

Related U.S. Application Data
(60) Provisional application No. 63/044,626, filed on Jun. 26, 2020.
(60) Provisional application No. 63/044,649, filed on Jun. 26, 2020.

(51) Int. Cl. A01M 17/00; A01M 21/04

(52) U.S. Cl. CPC A01M 17/00; A01M 21/04

(57) ABSTRACT

A soil beating apparatus comprising: (i) a frame configured to he detachably mounted to a support structure of a moveable gantry., (ii) an exhaust hood disposed in combination with the frame and having a shield directing heat downwardly toward a soil material to be heat treated, (iii) a plurality of plates each an end portion projecting downwardly from the exhaust hood toward the soil material and configured to be lowered into the soil material by the frame at a predefined depth relative to the ground plane of the soil material, and (iv) a burner disposed in combination with the exhaust hood and in fluid communication with a first supply of fuel and oxidizer, the burner configured to combust the first supply of fuel and oxidizer to beat each of the plates. The plurality of plates are oriented along a direction of motion of the moveable gantry to transfer heat into the soil material at the predefined depth to thermally heat-treat the soil material.

### CROSS REFERENCE TO RELATED APPLICATIONS

This application claims priority under relevant portions of 35 U.S.C. § 111 and 37 CFR §§ 1.51 and 1.53 to U.S. Provisional Patent Application Ser. No. 63/044,626, tiled on Jun. 26, 2020 and entitled: PRECISION SEEDING MACHINE FOR ROBOTIC GANTRY BRIDGE FOR FARMING and U.S. Provisional Patent Application Ser. No. 63/044,649, filed on Jun. 26, 2020 and entitled: SOIL HEATING DEVICE. Each of the above-noted applications are incorporated by reference in their entirety.

### BACKGROUND

In spite of the numerous chemical, genetic, and mechanical improvements made to farming in the past 50 years, fanning continues to be a costly and labor-intensive activity. To increase the scale and productivity of agriculture, fanners generally have resorted to the use of larger machines, larger plots, increased use of genetically modified seeds, higher use of chemicals, and increased use of low-wage workers. These approaches create the need for increased capital to purchase and maintain larger and more complex machines, present environmental issues, and often present labor problems.

Rows or raised beds of soil, particularly in soil greenhouses, can now be more thoroughly tilled, screened, and straightened as compared with typical soil rows in outdoor agriculture or in traditional hoop houses that cover soil. The formation of such regular rows or raised beds of soil are disclosed in U.S. Pat. No. 9,622,398 to John Paul Gaus, issued Apr. 17,2018, and entitled “Robotic Gantry Bridge for Farming,” the entirety of which is incorporated herein by reference. The availability of more meticulously formed soil rows, such as those created with the techniques disclosed in U.S. Pat. No. 9,622,398, presents an unmet need for improvements in high-precision seeding technology.

Conventional seeding machines utilize a variety of seed metering devices to deliver seeds into tubes or hoses at a measured rate For instance, conventional seeding machines utilize a variety of furrowing discs, wheels, or seeding shoes to open soil to a particular depth for the placement of seeds delivered into the tubes or hoses by seed metering devices. These conventional machines also provide a variety of methods for filling or covering openings in the soil after a seed has been deposited into such opening. Conventional machines are not capable of achieving highly precise seeding in more uniform soil beds with highly formed rows, and typically cause soil disturbance. The foregoing negatively impacts seed placement in a formed bed of soil; for example, causing irregularities in planting depths, which lead to irregularities in seed germination times and plant heights at time of harvest Thus, conventional seeding techniques limit potential crop yields.

Thermally treating soil before seeding is beneficial tor the purposes of killing weeds, killing weed seeds, and reducing soil pathogens. Steam is a very effective means of thermally treating soil. However steam does not burr, plant detritus, and effective steam treatment of soil in farm fields requires large, tractor-mounted or trailer-mounted steam generating devices. Steam treatment of soil in greenhouses is usually achieved with a cumbersome steam blanket that must be laid out over soil for long periods of time. The latter is labor intensive and time consuming. As an alternative, some people utilize direct flame torches. However, simple torches are not effective as heating the soil beneath the surface due to the insulating low heat transfer coefficient of soil.

### SUMMARY

A moveable gantry is provided for fanning operations comprising a plurality of propulsion mechanisms to drive the robotic gantry in a travel path along a plurality of crop rows. A frame connects to the propulsion mechanisms, straddles a predetermined number of the crop rows, and supports one or more modular farming implements having the ability to perform specific tasks.

A soil heating apparatus is provided comprising: (i) a frame configured to be detachably mounted to a support structure of a moveable gantry, (ii) an exhaust hood disposed in combination with the frame and having a shield directing heat downwardly toward a soil material to be heat treated, (iii) a plurality of plates each an end portion projecting downwardly from the exhaust hood toward the soil material and configured to be lowered into the soil material by the frame at a predefined depth relative to the ground plane of the soil material, and (iv) a burner disposed in combination with the exhaust hood and in fluid communication with a first supply of fuel and oxidizer, the burner configured to combust the first supply of fuel and oxidizer to heat each of the plates. The plurality of plates are oriented along a direction of motion of the moveable gantry to transfer heat into the soil material at the predefined depth to thermally heat-treat the soil material.

In another embodiment, a method for beating soil material is provided comprising the steps of (i) detachably mounting a soil heating apparatus to a moveable gantry, the soil heating apparatus including a plurality of plates each having an end portion projecting downwardly toward the soil material and configured to be lowered into the soil material at a predefined depth relative to, the ground plane of the soil material; (ii) burning a fuel and oxidizer between the plurality of plates to beat each of the plates, (iii) drawing the plurality of plates through a specific depth of soil to form a plurality of parallel grooves in the soil material; and (iv) thermally treating the soil by transferring heat from the plurality of plates to the soil.

This foregoing summary introduces a selection of concepts in a simplified form that are further described in the detailed description. This summary is not intended to identify key features or essential features of the claimed subject matter, nor is it intended that this summary be used to limit the scope of the claimed subject matter. Rather, this summary is intended to advise the reader of the general nature of subject matter described herein.

### BRIEF DESCRIPTION OF THE DRAWINGS

FIG. 1 illustrates an exemplary robotic gantry with wheels.

FIG. 2 illustrates an exemplary robotic gentry with flanged wheels.

FIG. 3 illustrates an exemplary robotic gantry with tracks.

FIG. 4 illustrates an exemplary robotic gantry in a raised position.

FIG. 5 illustrates a top diagrammatic view of a robotic gantry using a laser measurement device to determine its position.

FIG. 6 is a block diagram illustrating the propulsion mechanism, a controller, and an optional remote computer system.

FIG. 7 illustrates an exemplary flow diagram showing an example of the operation of the controller.

FIG. 8 illustrates exemplary computer architecture for devices capable of performing as described herein.

FIG. 9A depicts a perspective view of a seeding device viewed from an aft end thereof, in accordance with one or more aspects set forth herein;

FIG. 9B depicts a perspective view of the seeding device viewed from a forward end thereof, in accordance with one or more aspects set forth herein;

FIG. 9C depicts an enlarged profile view of a rotatable disc for producing a groove in the soil material and seeding tube of the seeding device, in accordance with one or more aspects set forth herein:

FIG. 9D depicts an enlarged, broken away, trailing edge view of the seeding device taken substantially along line 9D-9D of FIG. 9C;

FIG. 9E depicts another embodiment of the disclosure including a soil compaction and smoothing apparatus having a weighted roller pivotally mounted to the frame of the seeding device;

FIG. 9F depicts another embodiment of the soil compaction and smoothing apparatus including a compliant rake pivotally mounted to the frame of the seeding device;

FIG. 9G depicts another embodiment of the soil compaction and smoothing apparatus including an elongate brush pivotally mounted to the frame of the seeding device.

FIGS. 10A depicts a top perspective view of a soil heating apparatus, in accordance with one or more aspects set forth herein;

FIG. 10B depicts a bottom perspective view of the soil heating apparatus of FIG. 10A; and

FIG. 10C , depicts a cross-sectional view of the soil heating apparatus taken substantially along line 10C-10C of FIG. 10B.

FIG. 10D depicts a cross-sectional view of the soil heating apparatus taken substantially along line 10D-10D of FIG. 10C.

FIG. 10E depicts a top perspective, broken away view of the soil heating apparatus of FIGS. 10A and 10B.

### DETAILED DESCRIPTION

In the following detailed description, references are made to the accompanying drawings that form a part hereof, in which like numerals represent like elements throughout the several figures, and in which are shown by wav of illustration specific embodiments or examples. These specific exemplary embodiments are provided so that this disclosure will be thorough and complete, will fully convey the scope of the invention to those skilled in the art, and should not be construed as limiting The terminology used in the detailed description of tire particular exemplary embodiments illustrated in the accompanying drawings is use for convenience and clarity of explanation and is not intended to he limiting.

### Robotic Gantry

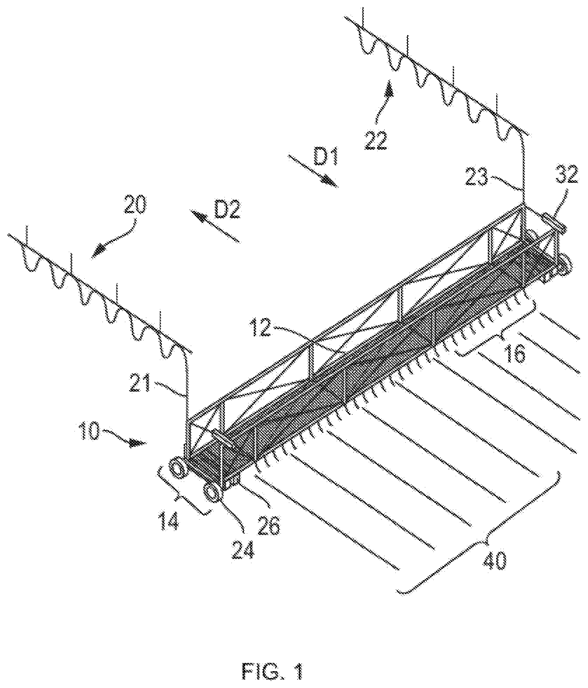

FIG. 1 illustrates an exemplary robotic gantry 10 with wheels 24. The robotic gantry 10 has a bridge 12 which is moved by propulsion mechanisms 14, has one or more forming implements 16, is connected to a power supply system 20, may be connected to an optional liquid or water supply system 22, and has one or more position detecting systems 30, 32. The robotic gantry 10 spans or straddles a plurality of crop rows 40 and travels along those rows. In the implementation of FIG. 1, foe propulsion mechanism 14 comprises one or more wheels 24 driven by motors 26.

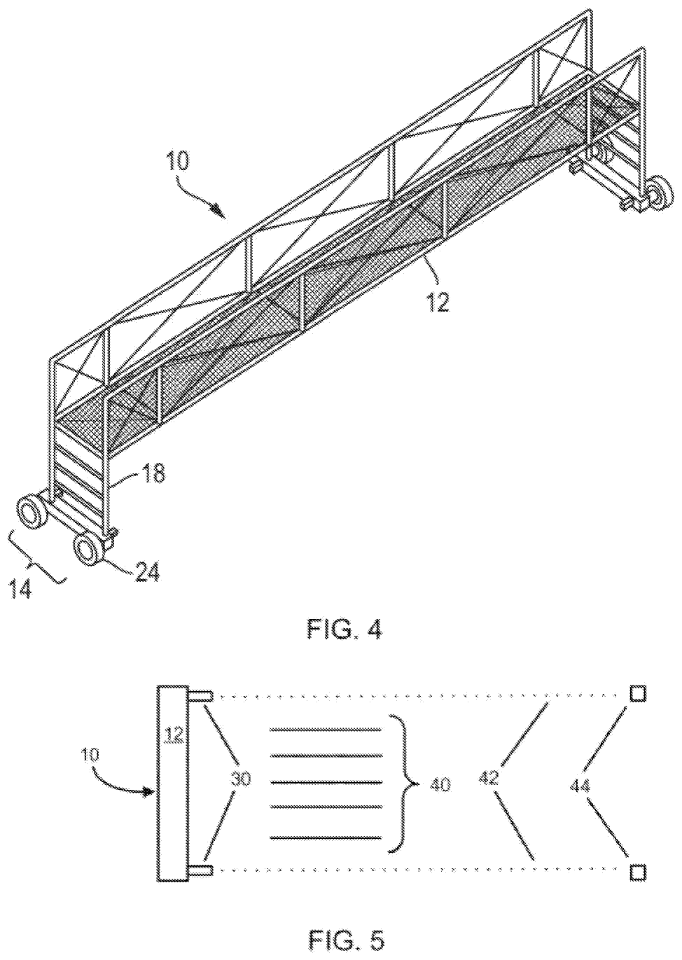

In the implementation of FIG. 1, the bridge 12 is in close proximity to the ground. As described further with respect to FIG. 4, the bridge 12 may be raised to a desired height above the ground by one or more height adjustment frames 18, preferably with one height adjustment frame 18 for each propulsion mechanism 14. Thus, the bridge 12 can accommodate a range of crop heights, ranging from lower height crops such as, for example, potatoes and cabbage, to higher height crops such as, for example, tomatoes, and vine crops, such as but not limited to grapes. “Crop” or “crops”, as used herein, includes food crops for humans, for food crops for animals, and non-food crops, such as flowers, lawn grass, etc.

The power supply system 20 may provide AC or DC power, as may be convenient, and as may be influenced by factors such as safety, cost, local electrical codes, etc. In one implementation the power supply system 20 is a festoon, as shown. Thus, as the robotic gantry 10 moves in direction D1, the electrical cable 21 extends along the festoon system 20 and, as the robotic gantry 10 moves in direction D2, the electrical cable 21 retracts along the festoon system 20. In another implementation, the power supply system 20 may comprise an electrical track system with two or more rails. In other implementations, the power supply system 20 may comprise rechargeable batteries which power the propulsion mechanisms 14, may be one or more internal combustion engines which directly power the propulsion mechanisms 14, or may be one or more internal combustion engines which charge rechargeable batteries which provide power to the propulsion mechanisms 14. The power supply system 20 may also power other applications on the robotic gantry such as, but not limited to, fans, pollination brushes, band saw harvesters, conveyer belts, tilling devices, control valves for liquids, a height control mechanism, positioning detectors, moisture sensors, pH sensors, cameras, pest abatement devices, and controllers, etc.

In one implementation the water supply system 22 is a festoon, as shown. Thus, as the robotic gantry 10 moves in direction D1, the water supply hose 23 extends along the festoon system 22 and, as the robotic gantry 10 moves in direction D2, the water supply hose 23 retracts along the festoon system 22. The optional liquid supply system 22 may provide water which is sprayed or dripped directly on or between crop rows 40, or may provide water which is automatically mixed with a desired additive, such as but not limited to fertilizer, pesticides, weed killer, etc., and then sprayed or dripped directly on or between crop rows 40. In one implementation the liquid supply system 22 is a festoon, as shown. In another implementation, the liquid supply system 22 may be a tank (not shown) which is carried by or on the frame 12 The tank option is less preferred because it adds weight to the robotic gantry 10, which consumes additional power and can compress the ground where the gantry 10 travels. The tank may still be advantageous, however, in some applications, particularly in the case of smaller tanks used for low volume liquids or to facilitate injection of additives to water.

The propulsion mechanism 14 comprises one or more motors, and may also include a shaft, wheel, or other encoder 28 to allow determination of the position of the robotic gantry 10, either alone or in conjunction with a laser ranging system 30. The information from the encoder 28 is preferably reset at the end of each direction of travel so that errors or variations in the output of the encoder do not accumulate.

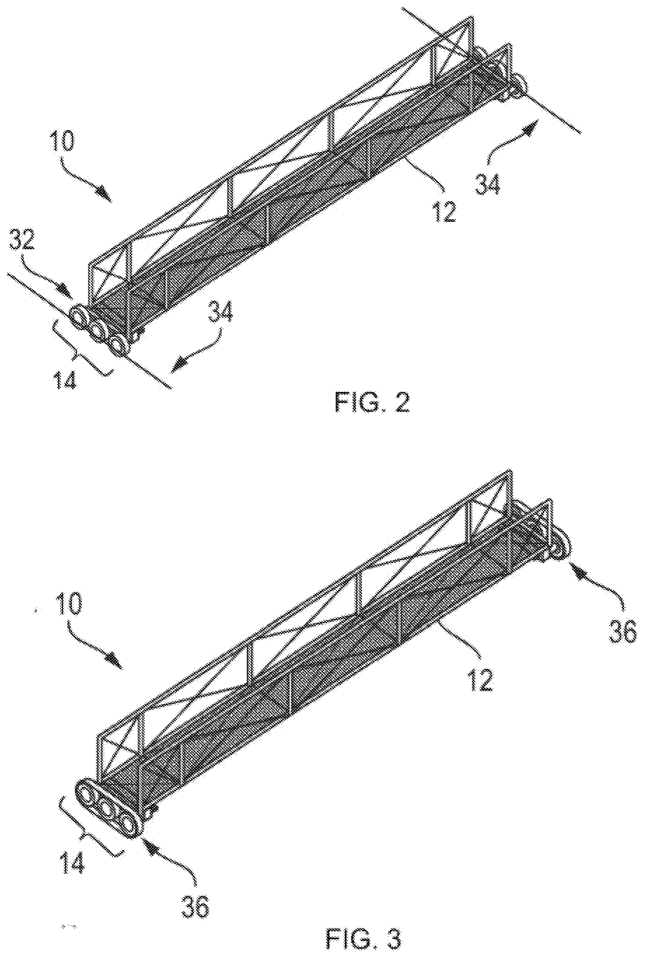

FIG. 2 illustrates an exemplary robotic gantry 10 with flanged wheels 32 to operate on rails 34 (e.g., operates on rails like a train), or on concrete ledges such as on the edge of greenhouse foundations. This implementation may be particularly useful in situations where there is a greenhouse foundation that may serve as a guide or a track, where it is preferred that wheels, tracks, etc., do not contact and/or compress the ground, or where the ground is ill-suited for wheels or tracks, such as watery areas, boggy areas, very muddy areas, rice fields, etc.

FIG. 3 illustrates an exemplary robotic gantry 10 with tracks 36 (e.g., like tracks on a bulldozer). This implementation may be particularly useful where it is desired to distribute the weight of the robotic gantry 10 across a larger ground surface area, or when the ground is such that wheels may tend to spin and dig in, such as sandy areas, but still avoid the additional expense of the rail system of FIG. 2.

FIG. 4 illustrates an exemplary robotic gantry 10 in a raised position with a height adjustment frame 18. The height adjustment frame 18 may be a single piece frame, in which case the height of the bridge 12 may be adjusted by removing a height adjustment frame IS having one height and replacing it with another height adjustment frame 18 having a different (larger or smaller) height. The height adjustment frame 18 may also comprise stackable sections, in which case the height of the frame 12 may be adjusted by removing or inserting sections.

In one implementation the height adjustment frame 18 is fixed, i.e., that particular robotic gantry 10 is dedicated to a particular crop or class of crops have a similar height. In another implementation the height adjustment frame 18 is adjustable and can accommodate a desired range of crop heights, such as by inserting and removing sections of the frame, or by selecting a desired connection point, such as a mounting hole or support, and affixing the gantry 12 to the frame 18 at that point. In another implementation the height adjustment frame 18 is remotely adjustable to accommodate a desired range of crop heights, such as a motor and gear system (not shown) or a motor and rack and pinion system (not shown) which can raise and lower the gantry 12 to a desired point on the frame 18. The motor may be manually operated or may be controlled by a computer system. Also, in another implementation, the gear system may be manually operated.

FIG. 5 illustrates a top diagrammatic view of a robotic gantry 10 optionally using a laser measurement device 30 to determine its position. Preferably, but not necessarily, two laser measurement devices 30 fire laser beams 42 toward known, fixed targets 44. The laser measurement devices 30 provide their respective measurements to a controller 38 which can use those measurements to make adjustments to the motors 26 so that the robotic gantry 10 moves in a straight line, i.e., along the rows 40, and does not twist or go off-path. Information from shaft or wheel encoders may be used in addition to, or instead of, the laser ranging information to determine the position of the robotic gantry 10 and make appropriate adjustments to the propulsion system 14 and to keep positional records of data gathered by sensing device on the robot.

This position information, from the laser ranging device 30 and/or the shaft or wheel encoders 28, may also be used to determine w hen a particular action is to be implemented. For example, a particular area may need additional water because the ground in that area has more clay or sand than another area, or that section gets more sunlight, etc. Therefore, the robotic gantry 10 may be programmed to provide a first amount of water for a first distance, and then a second amount of water for a second distance, the remainder of the row, etc. That can be done by controlling the forward/reverse speed of the robotic gantry, stopping the gantry at a desired point, backing up the robotic gantry to water that area again, increasing the water flow rate at that point, etc. Conversely, if a particular area needs less water because, for example, that area is at a lower spot and tends to collect and retain more water, then the robotic gantry 10 may be programmed to provide less water, or even no water, in that area, increase the speed while moving through that area, etc.

In contrast to crop dusters and larger irrigation systems, the frame 12 of the robotic gantry 10 operates in rather close proximity to the ground. The farming implements 16, such as sprinklers or pest abatement measures which deliver a desired effect, such as water, fertilizer, insecticide, or insect disturbance, etc., are configured such that the desired effect may be delivered in close proximity to the target areas. This increase effect while minimizing energy, resources, limiting waste, e.g., evaporative waste of the water, minimizes fertilizer and insecticide drift, minimizes pollution and contamination of surrounding areas from excessive application, etc. Also, the fanning implements 16 may be arranged on the frame 10 to deliver the desired product directly onto the row or crop, between rows, on every other row, every third row, etc., as appropriate to achieve a desired result. For example, there may two booms for applying liquids: one for watering at soil level, and another for spraying a pesticide mist. Also, a single boom could be used, and moved between high and low positions as needed.

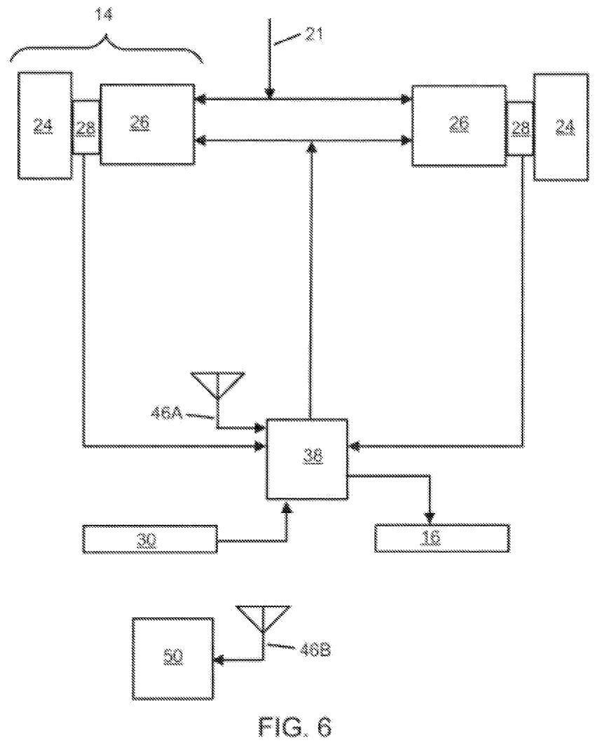

If the motors 26 are electric motors then it may be practical to directly drive the wheels 24, flanged wheels 32, or tracks 36 via shaft or chain. If the motors 26 are electric motors or combustion engines (which are also considered to be motors herein) then it may be necessary to drive the wheels 24, Hanged wheels 32, or tracks 36 via a gearbox and or appropriate sized gear sprockets and wheels to obtain the desired speed and torque. The motors 26 may be controlled by a central controller 38, or may have individual controllers which communicate with each and with the optional remote computer system 50 (FIG 6).

FIG. 6 is a block diagram illustrating the propulsion mechanism 14, a controller 38, and an optional remote computer system 50. As shown, as motor 26 drives a wheel 24 (or a flanged wheel 32 or a track 36). An optional encoder 28 reports the rotation of the wheel 24. The motor 26 receives operating power from the electrical cable 23, and control signals from the controller 38. The controller 38 receives position information from at least one encoder 28 and/or at least one laser ranging system 30. The controller 38 uses this position information to determine and control the desired operation of the motor 26, such as, forward, backward, stop, slow forward, etc., and to determine and control, and vary the speed of the desired operation of the attached farming implement(s) 16, such as, tilling speed, water on, water off, tilling tool up, tilling tool down, fans on or off, pest abatement devices on or off, etc. The controller 38 may be manually programmed on site, but may also receive operating instructions from the optional remote computer system 50 via a communications link, such as indicated by receivers or links 46A and 46B.

The optional remote computer system 50 may actively control the robotic gantry 10 by sensor information and position information and sending instructions in response to that information, or may provide operating parameters to the controller 38, which implements those operating parameters in response to received position information and or other information, such as soil moisture content, wind speed, the presence of pests or weeds, etc. The controller 38 is preferably powered from the power supply system 20 and may also possess backup power (not shown) to allow the controller 38 to store status information at the time of any power interruption, report the status information and power interruption to, for example, the optional remote computer system 50, and/or to give particular instructions to the motors 26 (e.g., stop) and/or the fanning implements 16 (e.g., turn off water, turn off fertilizer, return to standby position, etc.).

The location of the robotic gantry 10 and its movement or navigation back and forth along the rows 40 are, therefore, monitored and controlled using positional measurement devices 30, encoders 28, or other tracking or position measurement devices, such as, but not limited to, GPS receivers. These devices determine the location, speed, and rotation of the robotic gantry 10 so that it operates at the desired speed for a particular purpose, and navigates so that its wheels or tracks are parallel to each other, as well as to the plant rows 40, as the robotic gantry 10 repeatedly moves from one end of its workspace to the other, up and down the rows 40. The robotic gantry 10 can precisely determination its location, within a fraction of an inch, and gather and provide high-resolution and valuable data regarding the crops and their environment, including information regarding, plant growth rates, soil condition, the types and presence of pests and bugs. Such information maybe used by the controller 38 to instruct robotic operations, stored by the controller 38 for later retrieval and/or transmitted to the optional remote computer system 50.

The robotic gantry 10 may be located and operated in a covered space (such as a greenhouse, a hoop house, or other structure), may be located and operated in uncovered space such as farm field, or may be temporarily stored (e.g., overnight) in a sheltered area (e.g., a shed at the end of the rows 40) and then operated in uncovered space.

The robotic gantry 10 can use an array of passive or powered farming implements 16 for planting, pollinating, nurturing, and harvesting crops. Depending upon the implement(s) 16 desired, a particular farming implement may be attached, a procedure conducted, that implement removed, another implement attached, another procedure conducted, that implement removed, etc. Alternatively, two or more farming implements 16 may be attached, with the controller 38 directing the sequential or simultaneous operation of two or more various implements. These farming implements 16 may be fixed to the gantry 12, such as pointing ahead or down, or may move on the bridge 12, such as swiveling from side to side, or moving up and down, such as to plant seeds in tire ground. The height of the gantry may be lowered or raised to accommodate different types of plants as well as to adjust to the height of plants throughout a growing season.

Thus, the robotic gantry 10 can use a variety of farming implements to provide a variety of functions such as. but not limited to;

(a) spreading, depositing, dispersing or drilling devices for planting seeds and/or depositing fertilizer,

(b) row shaping and/or precision tilling implements;

(c) drip nozzles, spray nozzles, and/or mist nozzles for watering;

(d) chemical injection systems capable of injecting organic or other chemicals or substances into water or into spray nozzles for applying organic or other chemicals, or substances, directly to plants and/or soil;

(e)air nozzles and vacuum hoses for disrupting bugs and sucking bugs from plants, tor example, the air nozzles may provide bursts or putts of air, which alarm and/or dislodge the bugs from the crops, and the vacuum hoses then suck in the bugs, depending upon the height of the plant, there may be one or more nozzles, arranged vertically, and one or more vacuum hoses, also arranged vertically, there may be an air nozzle(s) and vacuum hose(s) arrangement for each row, for every other row, for every third row, etc. The air nozzle(s) and vacuum hose(s) may also move laterally on the bridge 12 so as to clean one row when the robotic gantry 10 is traveling in one direction, such as D1, and then clean another row when the robotic gantry 10 is traveling in the other direction, such as D2;

(f) acoustic wave (sound) generators for delivering a specific frequency, or a wide range of acoustic frequencies, at one or more power levels, to manage pests, such as insects, birds, rabbits, squirrels, especially, but not necessarily, when used along with air nozzle(s);

(g) vapor generation devices for managing pests and/or bugs by generating and dispensing mists, scents, and/or chemicals which repel or kill bugs, or disrupt mating cycles and/or interrupt the ability of the pest or bug to identify its preferred food source;

(h) ionic air generators to promote plant health and repel pests;

(i) lights capable of generating a specific wavelength or wavelengths of light, including visible light, infrared light, and/or ultraviolet light, or a wide or narrow spectrum of such light, at desired light level(s), to confuse, alarm, or drive away hugs and pests, and/or promote plant health;

(j) electromagnetic frequency generators capable of generating a specific radio frequency or frequencies, or bands of frequencies, at desired power level(s), to disrupt and manage pests and/or promote plant biological responses;

(k) harvesting, packing, and/or storage devices for harvesting specific crops or a general class of crops; and

(1) monitoring and data gathering devices and sensors, such as time of flight cameras, laser scanners, color sensors, moisture sensors, wind speed and/or direction sensors, motion sensors, humidity sensors, infrared sensors, to detect anomalies in leaf surfaces, moisture, heat, cold, or heat signatures of bugs pests, biological detection devices, such as pH detectors, motion detectors, chemo-luminescence analysis. nano-sensors. etc., for monitoring, measuring or determining environmental data around the crops, such as condition of the soil, air and water around the crops, plant growth rates, pest and/or bug attacks, and biological targets such as mold, fungus, disease, botulism, salmonella, listeria or other sources of potential food borne illnesses.

Thus, the described robotic gantry 10 may be tethered to power and water, is self-navigating, can move at adjustable speeds, and is able to carry and use an array of farming implements 16 that reduce the labor required to work the soil, form rows and beds, plant crops, pollinate crops, water crops, manage pest control on crops, cultivate crops, detect disease, and automate the harvest of crops. The robotic gantry 10, along with one or more of its described farming implements 16, thus automates and enhances the planting, nurturing and/or harvesting of crops, enables various automated, chemical and/or non-chemical pest management techniques that are currently not possible or highly difficult using conventional techniques and devices, enhances the precision and/or speed of delivery of seed, water, fertilizer, etc., and reduces the amount of labor requited.

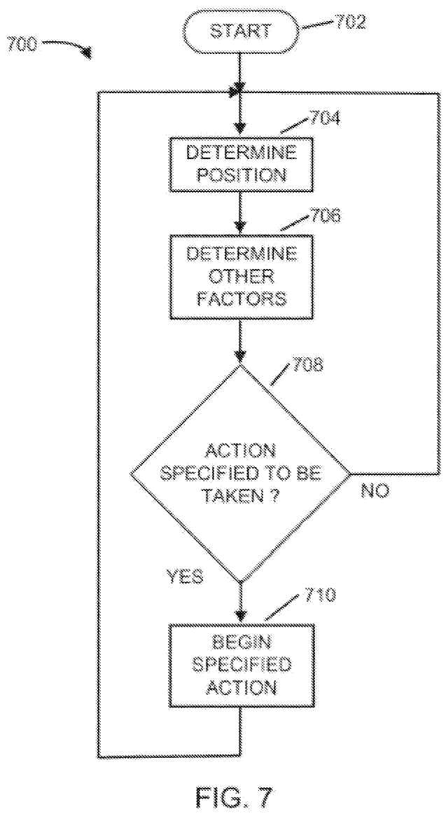

FIG. 7 illustrates an exemplary flow diagram 700 showing an example of the operation of the controller 38. Upon starting 702 the controller 38 determines its position 704 and determines other factors 706, such as, but not limited to, soil moisture content, wind speed, wind direction, humidity, sunlight level, etc. It then determines whether an action 708 is specified or permitted to be taken based upon the position or the other factors. If not, a return is made to step 704 for the next position determination, which may be after some predetermined delay or wait time. If so, then a specified action 710 is initiated. A return to step 704 is made for the next position determination. It should be understood that the operations of the procedure 700 disclosed herein are not necessarily presented in any particular order and that performance of some or all of the operations in an alternative order(s) is possible and is contemplated. The operations have been presented in the demonstrated order for ease of description and illustration Operations also sometimes referred to herein as “actions”, may be added, omitted, and/or performed simultaneously, without departing from the scope of the appended claims.

Consider now an exemplary operation of the robotic gantry 10. Upon starting 702 the controller 38 will determine its position 704. The controller 38 will also determine other factors 706, such as environmental factors. Assume, for the determined position 704, that it may be appropriate to begin an operation to, for example, spray an insecticide. Further assume, however, that the current wind speed is 15 mph. The controller 38 then determines, based upon the wind speed, that the spraying operation is not needed. The controller 38 may then return to position 704 to begin the process again until the wind speed is sufficiently low, or to initiate a different operation instead.

Assume, instead, that a determined position 704 was reached, and the action at that point was to till the soil to prepare the ground for a new crop. The controller 38 would then, at step 710, instruct the tiller equipment 16 to deploy and instruct the motors 26 to begin moving the robotic gantry 10 forward (or backwards, as the case may be). The controller 38 may instruct a seeding device to insert a seed into the tilled soil. Thus, two or more operations or actions may be started (or ended) at the same time, or at different times A return is then made to step 704 where the position and other factors 704, 706 may again be assessed. At some point, the robotic gantry 10 will have reached the end of a row so the controller 38 may instruct the motors 26 to stop, to reverse its direction of travel, and/or to continue to operate or raise tire tiller and the seeding device, it may also instruct the motors 26 to begin a reverse path, and instruct the farming equipment/implements 16 to deploy a watering nozzle to water the ground where the seed has recently been placed. On the return to position 704, the controller 38 may terminate an ongoing action and or begin a new action. At some point, based on the other factors 708 (which may include date, time, and a completion of a designated operation or operations), the controller 38 may: (i) stop all operations for the day, (ii) return to a starting point, (iii) stop in place, (iv) wait for a sensor to indicate that an action should be taken, (v) wait for a start or resume signal from the optional remote computer system 50, and/or, (vi) wait for the human operator to repair or replace a piece of farming equipment or a farm/implement 16, etc. It will be appreciated that some farming implements 16 may be mounted such that they are considered to be already deployed, or permanently deployed, such that they merely require activation or deactivation For example, a sprinkler system and a tilling implement 16 may be permanently mounted along the underside of the gantry 10 such that activation is the only step required for use or movement of the gantry 10. Other modular farming, implements 16 such as the soil heating and robotic seeding devices described in subsequent sections, may be deployed, retracted or removed from the gantry 10.

It also should be understood that the illustrated procedure 700 can be ended at any time and need not be performed in its entirety, Some or all operations of the procedure 700, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like.

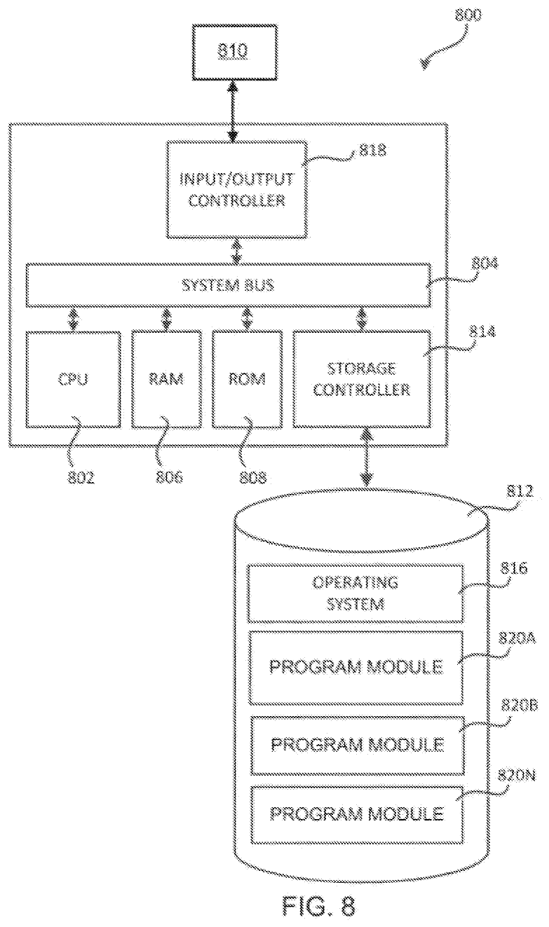

FIG. 8 illustrates exemplary computer architecture suitable for the controller 38 and for the optional remote computer system 50. The computer architecture 800 may be utilized to execute any aspects of the software operations presented herein. Although a microprocessor-based implementation is preferred because of flexibility and versatility, the robotic gantry 10 may also be controlled using other components such as, for example, relays, limit switches, and timers, especially where the actions to be performed are somewhat basic such, tor example, make one pass down the rows 40 and then stop, make a pass and a reverse pass and then stop, make a specified number of passes and reverse passes and then stop, start and stop at predetermined times, etc.

The exemplary computer architecture 800 includes at least one central processing unit 802 (“CPU”), a system memory including a random access memory 806 (“RAM”) and a read-only memory (“ROM”) 808, and a system bus 804 that couples the memories 806, 808 to the CPU 802. A basic input/output system containing the basic routines that help to transfer information between elements within the computer architecture 800, such as during startup, is stored in the ROM 808 The computer architecture 800 further includes a mass storage device 812 for storing the operating system 816 and one or more programs or modules 820A-820N.

The mass storage device 812 is connected to the CPU 802 through a mass storage controller 814 connected to the bus 804. The mass storage device 812 and its associated computer-readable media provide non-volatile storage for the computer architecture 800. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 800.

Although the memories 806 and 808 and mass storage device 812 are preferably separate components, one or both of the memories 806 and 808 could be included in the mass storage device 812. The memories 806 and 808 and mass storage device 812 may be collectively considered to be, and referred to as, a memory device.

Other components may also be implemented. For example, a radio frequency (RF) transceiver 810 may be connected to antenna 46A, 46B to provide a communications link between a controller 38 and die optional remote computer system 50. In the case of the controller 38, the encoder 28, laser ranging device 30, or sensor (moisture level detector, light level detector, microphone, camera, etc.) may be connected via the input output controller 818. Controlled devices may he connected via the input/output controller 818, and may include, by way of example and not of limitation, the motors 26, the laser range finder 30, valves to turn the water supply on or off, or at some desired level, motors to raise, lower, swivel, rotate, etc., and various farming implements 16. “Communications link” includes any modulated data signal such as a carrier wave or other transport mechanism and includes any delivery media live term “modulated data signal” means a signal that has one or more of its characteristics changed or set in a manner as to encode information in the signal. By way of example, and not limitation, “communications link” includes wired media such as a wired network or direct-wired connection, and wireless media such as acoustic, RF, infrared, optical, and other wireless media, and combinations of any of the above.

The input/output controller 818 may also be connected to one or more user input devices (not shown) such as, but not limited to, a keyboard, mouse, touchscreen, touchpad, keypad, or electronic stylus. Similarly, the input/output controller 818 may provide output to one or more user display devices (not shown) such as, but not limited to, a display screen, a printer, or other type of output device. A user input dev ice and a user output device may be embodied in the same component, such as a touch-sensitive screen. The user input device and the user output device may be integral with the device, such as in the case of a handheld device, or may be separate components, such as a keyboard, mouse and display used with many desktop systems.

It should he appreciated that the software components described herein, when loaded into the CPU 802 and executed, transform the CPU 802 and the overall computer architecture 800 from a general-purpose computing system to a special-purpose computing system customized to facilitate the functionality described herein. The CPU 802 may be constructed from any number of transistors or other discrete circuit elements, which may individually or collectively assume any number of states. More specifically, the CPU 802 may operate as a finite-state machine, in response to executable instructions contained within the software modules disclosed herein. The CPU 802 may he a single processor, or may be a plurality of processors. These computer-executable instructions may transform the CPU 802 by specifying how the CPU 802 transitions between states, thereby transforming the transistors or other discrete hardware elements constituting the CPU 802.

Encoding the software modules may transform the physical structure of the computer-readable media. The specific transformation of physical structure may depend on various factors, in different implementations. Examples of such factors may include, but are not limited to, the technology used to implement the computer-readable media, whether the computer-readable media is characterized as the primary or secondary storage medium, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture in order to store and execute the software components presented herein. It also should be appreciated that the computer architecture may include other types of computing dev ices, including hand-held computers, embedded computer systems, personal digital assistants, and other types of computing devices known to those skilled in the art. It is also contemplated that the computer architecture may not include all of the components shown herein, may include other components that are not explicitly shown herein, or may utilize an architecture completely different than that shown herein.

### Modular Seeding Device for Robotic Gantry

In another embodiment, the robotic gantry 10 may include a modular seeding implement or device for precision seeding in highly regular, formed, soil rows or raised soil beds. Advantageously, the modular seeding implement is particularly useful when seeding in combination with automated or robotic equipment, such as the robotic gantry 10 discussed in the previous section. Advantages of the modular seeding implement includes precision seeding resulting in: 1) uniformly distributed seeds, 2) precise seeding depths when depositing the seeds in soil, 3) uniform germination of seeds, and 4) uniform height of the crop at the time of harvest. The modular seeding device, therefore, results in more plants at the time of harvests, regular harvest processes, and higher harvested yields. These advantages are achieved by minimizing soil disturbance, precise seed placement, and uniform seed spacing and depth. This increases regularity in both seed germination and plant height at the time of harvest. Plants with the same height, i.e., at time of harvesting, allow for more uniform harvesting techniques with improved crop yields.

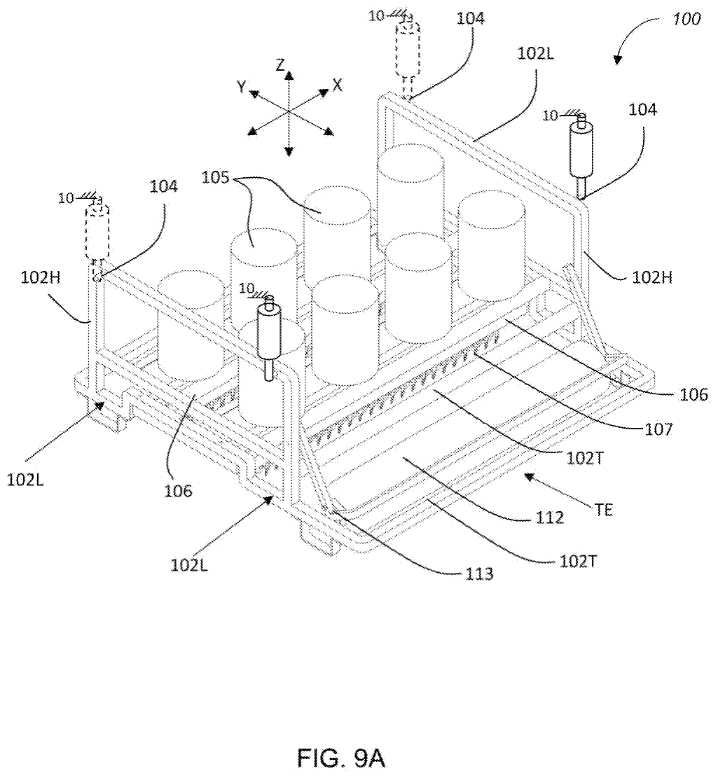

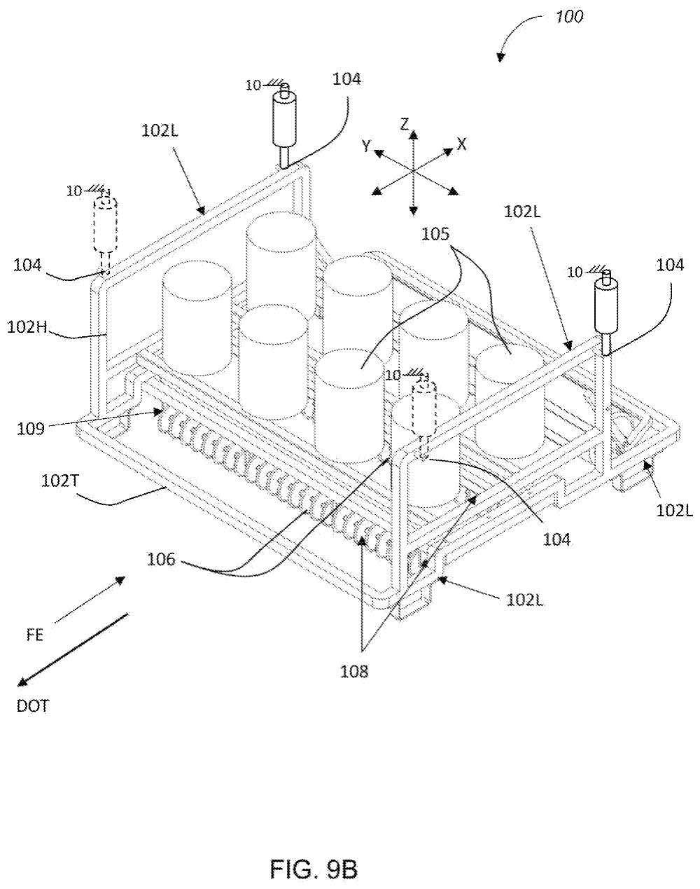

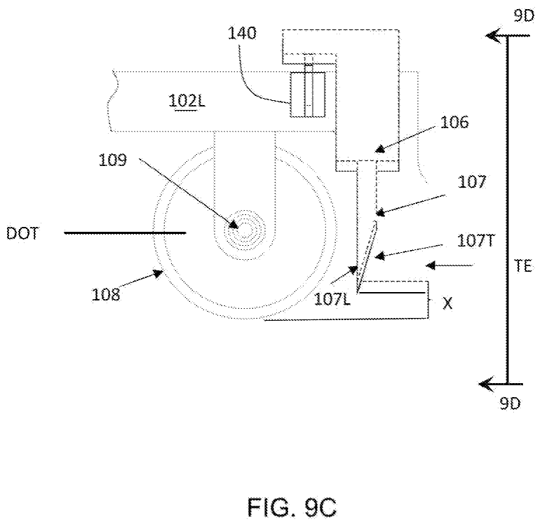

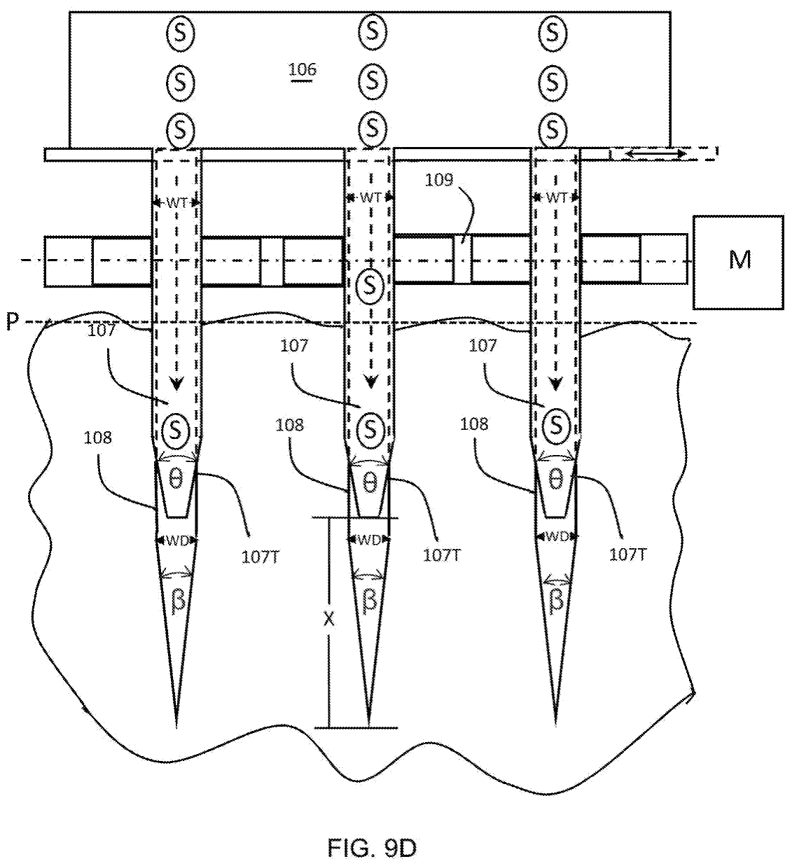

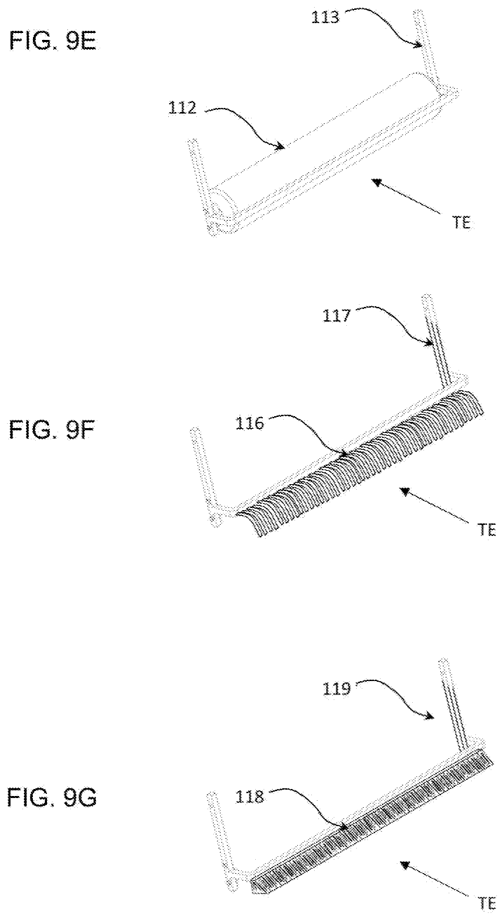

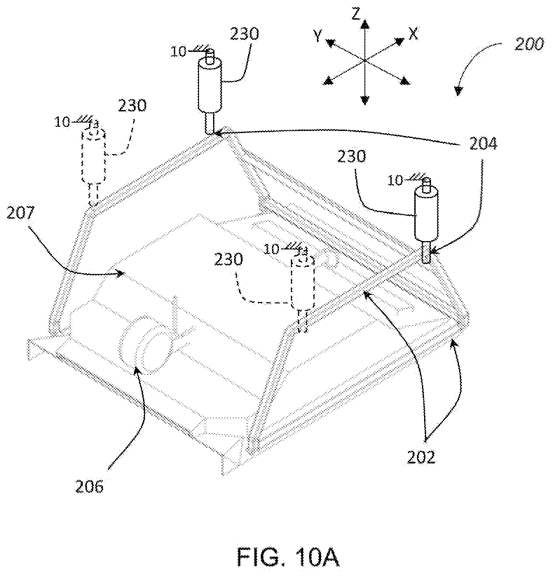

FIGS. 9A-9B depict a modular seeding implement comprising a seeding device 100 viewed from an aft and forward end, respectively. In the embodiment of FIG. 9A, the seeding device 100 includes a frame 102 detachably mounted to a moveable/robotic gantry device 10, such as that described hereinbefore). The frame 102 comprises at least one vertical support structure 102H defining a height dimension of the seeding device 100 when mounted to tire gantry device, i.e., the Z-axis of a C artesian Coordinate (CC) system, a transverse cross-member 102T defining an axis orthogonal to the vertical support structure 102H, i.e., the X-axis of the CC system, and a longitudinal support 102L defining an axis orthogonal to the transverse cross-member 1021, i.e., the Y-axis of the CC system. In the described embodiment, the frame 102 may have a plurality of locking or attachment pins 104 extending from the exterior of the frame 102 for rapid attachment/detachment to the gantry device 10. While a robotic gantry device 10, described supra, may be most suitable for use in combination with the seeding device 100, it will be appreciated that other movable gantry devices may be employed for directing and transporting the seeding device 100.

The seeding device 100 includes a plurality of seed containers 105 for dispensing seed material into one of a plurality of seed metering devices 106 disposed in parallel relation with an upper portion of the frame 102. In FIGS. 9A-9D, the seed metering devices 106 deliver the seeding material S (see FIG. 9C) into a plurality of vertically oriented, spaced-apart, seeding tubes 107 disposed beneath the seed metering devices 106. That is, seeding material S is delivered to the seed metering devices 106 from the seed containers 105 and dispensed into each of the seeding tubes 107. In the described embodiment, the seeding material S is dispensed under the force of gravity, or through other means including pneumatic pressure, a mechanical belt or other arrangements facilitating dispensation of the seeding material.

The modular seeding device 100 may be disposed in combination with rows of rotating discs 108 disposed upstream of the seeding tubes 107. One of the rows of rotating discs 108 is disposed at a forward end FE (see FIG. 9B) of the frame 102 while the remaining row or rows 108 may be interposed between the forward and aft ends FE, TE of the frame 102 (see FIG. 9A). In addition, a pair of parallel metering devices 106 may be provided in spaced-relation on the frame 102 to which are fixed the rows of seeding tubes 107.

In the described embodiment, the frame 102 may be attached to a tractor or other vehicle, and is ideally attached to the robotic gantry 10 described hereinabove for farming. The direction of travel is shown by the arrow DOT in FIGS. 9B and 9C. In one embodiment, the rotating discs 108 are disposed in close parallel relation to one another and are crafted with sharp edges, shaped and configured, to cut or plow consistent grooves in the soil while minimally disturbing the soil surface and/or creating an irregular soil geometry. The rotating discs 108 are all the same diameter, and are mounted to a shaft 109 that can rotate freely. Furthermore, each disc 108 may rotate freely on the shaft 109, hence, the discs 108 may rotate independently or in unison.

Each row of seeding tubes 107 is mounted on a transverse bar of the seeding device 106 and spaced such that each seeding tube 107 is substantially aligned with, and downstream of, a corresponding rotating disc 106. According to the described embodiment, two sets of rotating discs 108 are disposed in combination with corresponding rows of seeding tubes 107, although any number of rows or sets of discs 108 and tubes 107 may be employed. In the described embodiment, each disc defines a width dimension WD which is slightly less than the width dimension WT of the respective downstream seeding tube 107. Each of the seeding tubes 107 is generally cylindrical and has an external width dimension of about one-quarter inches to about one half inches (¼″-½″) in width, and preferably between about one-quarter inches to about three eighths inches (¼″-⅜″) in width, or about the thickness of a typical straw or pencil.

In FIGS. 9C-9D, the seeding tubes 107 are commonly defined by a selectively shaped tip end. The tip end includes a leading edge 107L and a shaped trailing edge 107T so that the tubes 107 may travel below the level of the soil bed and driven in the narrow soil groove carved by the freely rotating disc 106. More specifically, each seeding tube 107 has a beveled or angled tip end similar to the tip of a syringe needle. The leading edge 107L is vertical and faces the corresponding rotating disc 108 while the sloping or angled trailing edge 107T faces away or downstream of the rotating disc 108 The selectively shaped tip end, therefore, prevents the seed deposition opening from filling with soil material while traveling within each of the grooves produced by the rotating disc 108.

In the described embodiment, each seed metering device 106 may be independently raised and lowered to vary the height of the seeding tubes 107. Such adjustment accommodates the very precise placement of different types of seeds. In one embodiment of the disclosure, the seeding device 100 may be mounted to at least two (2) Linear Displacement Vertical Transducers (LYDTs) or actuators 130 disposed between the frame 102 and the robotic gantry 10. Accordingly, the height of the frame 102 may be controlled relative to the plane F of the soil material. Alternatively, three or more LVDTs 130 may be interposed between the frame 102 and the robotic gantry 10 to control or vary the height and the planar orientation of the frame 102 relative to the plane P of the soil material. Consequently, the LVDTs and/or actuators 130 may effect highly precise height and planar adjustment of the seeding device 100.

The seeding device 100 may be towed or pushed by a tractor or other vehicle. Ideally the device 100 is attached to the robotic gantry device 10 which is powered and self-navigated at adjustable speeds. The seeding device, therefore, is capable of metering the linear spacing and depth of the seeding material S planted in the soil material. The linear spacing may be controlled by the speed of the robotic gantry 10 and the rate of seed delivery by the seed metering device 100. Furthermore, the depth of the seeding material is controlled by the adjustable height of the seeding device 100 and the depth of the seeding tubes relative to the ground plane of the soil material. Consequently, the seeding dev ice 100 allows for a wide range of highly precise seeding of multiple seed types in a formed, raised bed, or row, of soil.

In one embodiment, the height of the entire frame 102 of the seeding device 100 may he adjusted for use to establish the depth at which the edge of the rotating discs 106 penetrate the soil. Consequently, the depth of the seeds are metered by the depth of the seeding tubes 107. In another example, the height of the seeding tubes 107 may be adjusted relative to the height of the rotating discs 106 to control how different types of seeds fall into the soil penetrations/grooves created by the discs 106. In the described embodiment, the leading edge 107L of each seeding tube 107 may be raised a threshold height X above a horizontal line of tangency with the maximum depth of the rotatable disc 108 An actuator 140 may be interposed between the frame 102L and the seed metering device 106 to raise and lower the seeding tubes 107 relative to the rotatable discs 10B so as to vary the threshold height X. The threshold height X is preferably between about one to two inches (1.0″ to 2.0″) in depth. In a further example, the rate at which seeds are deposited into the plurality of seeding tubes 107 may be controlled with a number of any commercially available seed metering devices.

In another example, the rate at which the device 100 moves combined with the adjustable height of the device 100, the adjustable height X of the seeding tubes 107 relative to the rotating discs 106, and the rate at which seeds are deposited into the tubes 108 allows for a wide range of very precise seeding depths, distributions, and rates.

In FIG. 9E, a weighted roller 112 is pivotally mounted to the frame and disposed downstream of the seeding tubes for compacting and collapsing the soil material to cover the seed material for germination. In the described embodiment, the roller 112 is mounted to a pivoting frame 113 which is pinned to the frame or the seeding device 100. Alternatively, the roller 112 may be telescopically mounted to the frame and spring-biased against the soil surface by an internal spring mechanism. In FIG. 9F, a plurality of compliant rakes 116 may be mounted to an arm or frame 117 which may be pivotally or fixedly mounted to the frame of the seeding device 100. In FIG. 9G, a brush 118 may be mounted to an arm or frame 119 which may be pivotally or fixedly mounted to the frame of the seeding device 100.

In summary, seeding device 100, when used on well prepared soil rows and/or raised beds, enables precise deposition of seeds, at precise spacing, and at precise depths. Such precision (i) increases the number of seeds germinating at the same time, (ii) ensures that each deposited seed is optimally spaced for its intended size of final planting, (iii) increases the number of plants that are the same height at time of harvest, and (iv) improves regularity of plants, harvest methods and yields. The combination of these outcomes increases the value of crops, reduces waste, and improves harvest and economic outcomes.

### Modular Soil Heater for Robotic Gantry

In another embodiment, the present disclosure teaches an apparatus for the thermal treatment of soil material, such as a soil heating/burning apparatus. Advantageously, the present soil heating apparatus fills a need for thermally treating soil with a compact apparatus capable of burning plant detritus and delivering high temperatures at target depths beneath the soil. In one embodiment, a soil heating apparatus can use multiple fuels to achieve its goals with direct flame treatment of soil, and, is particularly well-suited for use with a propane fuel. The apparatus can be utilized in fields or greenhouses with tractors or other vehicles. In particular, the apparatus is well-suited tor use in greenhouses with a Robotic Gantry Bridge for Farming, such as that taught in Gaus U.S. Pat. No. 9,622,398, referenced above.

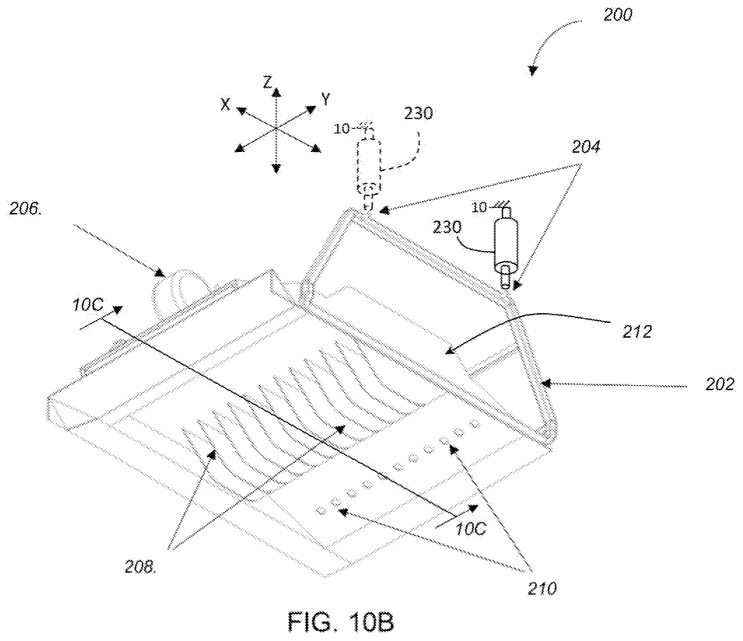

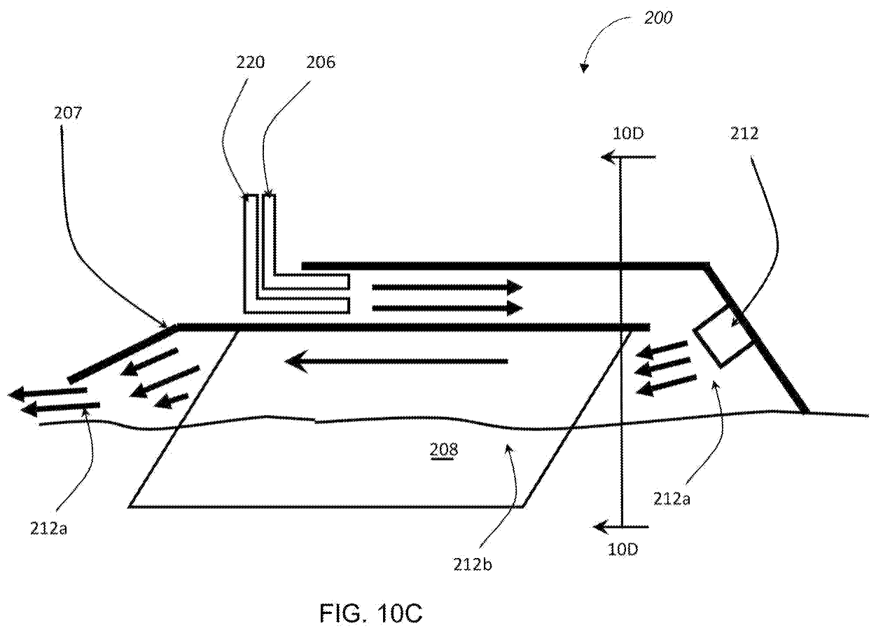

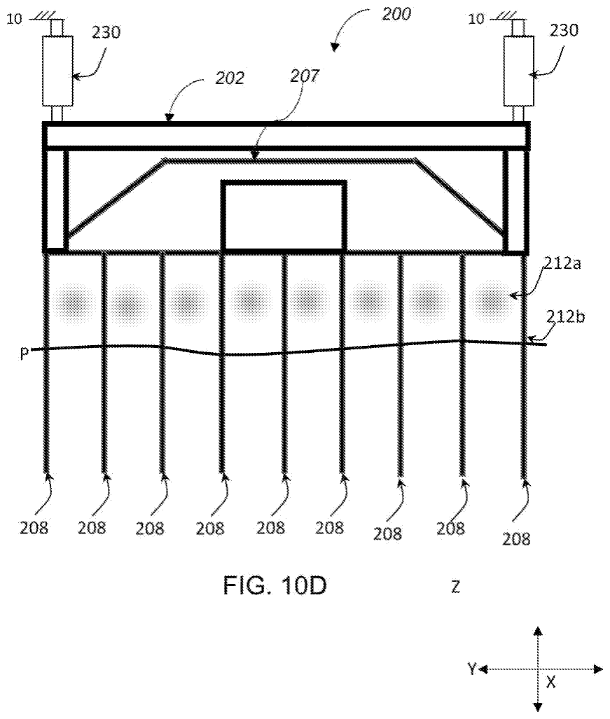

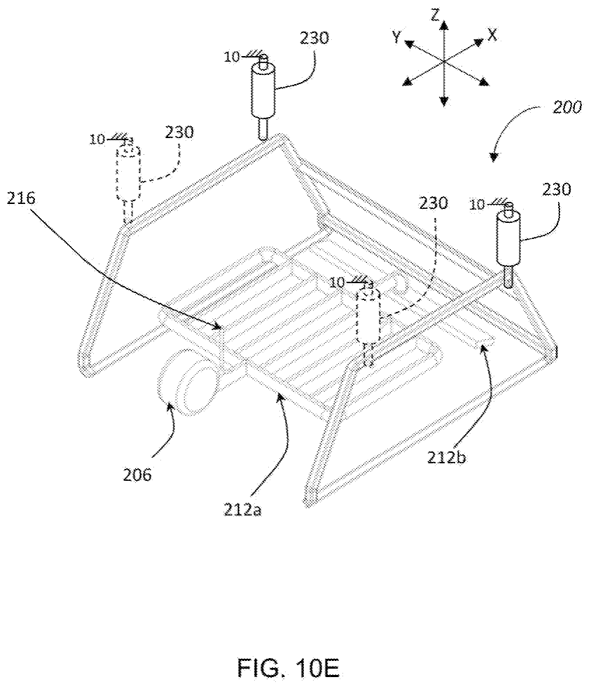

FIG. 10A depicts a soil heating apparatus 200 in accordance with one embodiment of the invention. In the described embodiment, soil heating apparatus 200 includes a frame 202 having four connection points in the form of attachment pins 204 disposed at the upper end of the frame 202 and in spaced relation, with each attachment pin 204 being exteriorly disposed. In one embodiment of the disclosure, the soil heating apparatus 200 may be mounted to at least two (2) Linear Displacement Vertical Transducers (LVDTs) or actuators 230 disposed between the frame 202 and the robotic gantry 10. Accordingly, the height of the frame 202 may be controlled relative to the plane P of the soil material to be treated. Alternatively, three or more LVDTs 230 may be interposed between the frame 202 and the robotic gantry 10 to control or vary the height and the planar orientation of the frame 202 relative to the plane P of the soil material. In the illustrated embodiment, four (4) actuators 230 are shown. Consequently, the LVDTs and/or actuators 230 may effect highly precise height and planar adjustment of the soil heating apparatus 200.

The frame 202 is configured to secure a plurality of components including an exhaust hood 207 that is shaped and configured to cover the area of soil to be treated. In FIG. 10B, the soil heating apparatus 200 includes a set or plurality of parallel plates 208 disposed beneath the hood 207. The plurality of parallel plates 208 are fabricated front metal or other thermally conductive material that is configured and supported within the apparatus 200 to extend above and below the surface of the soil. The plates 208 are configured to be lowered and extend a select depth into the soil material, which depth determines the dimensions of the plates 208.

A burner 212 is disposed in combination with, and more particularly, arranged above the plurality of parallel plates 208 so that a first section 212a of the burner 212 heats the surface P of the soil material and a second section 212b heats the plates 208 as the heating apparatus 200 moves in relation to, and over, the soil material. The heated plates 208 are disposed below the exhaust hood 207 to cut grooves in the soil for the purpose of transferring heat into the soil material and below the plane P of the soil surface. Hence, the surface P of the soil material and the soil at a selected depth are heat-treated as the apparatus 200 moves through the soil material.

As depicted in FIGS. 10C and 10D, the soil heating apparatus 200 includes the second burner section 212b, disposed in series with the first burner section 212a, that projects a flame between the channels 208C of the plates 208 while at the same time burning detritus on the surface P of the soil material. That is, fuel and oxidizer are combusted and forced between the channels to effect convective heat transfer to the plates 208, which in turn conductively transfer heat beneath tire surface P to a depth of about three (3) to four (4) inches below the surface. The burner 212 comprises a plenum wherein a row of nozzles 210 are oriented orthogonally of the plates 208. Each nozzle 210 is aligned with a channel 208C between the plates 208. In the described embodiment, the first section 212a burner 212 heats the surface P of the soil material while the second portion 212b heals the plates 208 to transfer heat below the surface P While in the described embodiment, the first and second sections 212a, 212b are fed by a single burner 212, it will be appreciated that each section may be healed by a separate burner, i.e., a first and second burner, disposed in series or in parallel.

In FIG. 10F, a blower 200 may be coupled to the manifold of the burner 212 to direct the oxidizer, i.e., ambient air, into an inlet 220 of the blower 206, through the manifold and, subsequently, to the plenum of the burner 212. While the first and second burner sections 212a and 212b may operate independently, the combustion fuel from a fuel inlet 216, and the combustion air from the blower 206 may be mixed in the manifold before being conveyed to the burner sections 212a, 212b. Alternatively, combustion fuel and oxidizer/air may be pre-heated in a separate manifold and exhausted directly onto the surface P of the soil material or between the plates 208.

Although a specific configuration of the burner has been depicted, any suitable arrangement for heating the plates 208 and the ground ahead of and between the plurality of parallel plates 208 may be used. Advantageously, heating the plates 208 and the ground allows for heat treatment of the soil both above and below the surface.

In operation, the burner nozzles 210 are aimed downwardly towards the soil material and the between the plates 208. The flames from the burner 212 heat the plates 208 and the soil by a combination of conduction and convention. The heated plates 208 and the grooves formed in the soil achieve two important outcomes, (i) the geometry created by the channels and grooves increases heat transfer to the soil, and, (ii) the direct contact of the heated plates 208 with the soil significantly increases heating the soil material to a selected depth at which the plates 208 penetrate the soil. The direct flame and high operating temperatures under the exhaust hood 207 reduce plant detritus to ash, which can further benefit the soil biome by the addition of carbon, i.e., a fertilizing mineral, into the soil material.

Tire frame 202 of the apparatus 200 may be carried on the front or back of a moveable gantry, robotic gantry, tractor or other farm vehicle via a two or three-point hitch or other connection mechanism. Tire machine frame 202 is particularly suitable for mounting to a 4-point connection mechanism using locking pins 204 for mounting on a Robotic Gantry Bridge for Farming.

In one embodiment, the dimensions of the parallel plates 208 may be varied to reach varying depths in the soil. In another embodiment, the volumetric flow of air through the blower 206 and fuel in the fuel delivery manifold of the burner 212 may be increased or decreased to vary the flame volume and temperature, in another embodiment of the disclosure, mist or water, mixed with alcohol or other combustible material, may be optionally injected under the exhaust hood 207 using a separate electrically-powered misting apparatus to achieve both direct flame and steam treating of the soil.

The rate at which the heating apparatus 200 moves relative to the soil combined with varying: (a) the number and size of the plurality of parallel plates 208, (b) the flow rates of air and combustion fuel to the burner 212, arid (c) the optional injection of mist or water (e.g., using an electrically-powered pump attached above the exhaust hood 207) with or without added combustibles allow for a compact and effective approach for thermally treating soil and burning plant detritus to varying degrees.

Computer storage media may include volatile and non-volatile, removable and non-removable media implemented in any method or technology for storage of information such as computer-readable instructions, data structures, program modules or other data, for example, computer storage media includes, but is not limited to, RAM ROM, EPROM, EEPROM, flash memory or other solid state memory technology. CD-ROM, digital versatile disks (“DVD”), HD-DVD, BLU-RAY, or other optical storage, magnetic cassettes, magnetic tape, magnetic disk storage or other magnetic storage apparatus, or any other medium which can be used to store the desired information and which can be accessed by the computer architecture 800. For purposes of the claims, the phrases “computer storage medium”, “computer storage media”, and variations thereof, do not include waves, signals, and/or other transitory and/or intangible communication media, per se, and the broadest reasonable interpretation of these terms does not include waves, signals, and/or other transitory and or intangible communication media per se, or interpretations which are prohibited by statutory or judicial law.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, steps, operations, elements, and/or components, but do not preclude the presence or addition of one or more other features, steps, operations, elements, components, and or groups thereof.

It will be understood that when an element is referred to as being “connected” or “coupled” to another element, it can be directly connected or coupled, mechanically, hydraulically, electrically, electronically, wirelessly, etc., to fire other element, or intervening elements may be present.

As used herein, the term “and/or” includes any and all combinations of one or more of the associated listed items. As used herein, phrases such as “between X and Y” and “between about X and Y” should be interpreted to include X and Y unless otherwise specifically noted. Further, terms such as “about”, “approximately”, and “substantially” are relative terms and indicate that, although two values may not be identical, their difference is such that the apparatus or method still provides the indicated or desired result, or that the operation of a apparatus or method is not adversely affected to the point where it cannot perform its intended purpose. As an example, and not as a limitation, if a height of approximately “X” inches is recited, a lower or higher height is still approximately “X” inches if the desired function can still be performed or the desired result can still be achieved.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. For brevity and/or clarity, well-known functions or constructions may not be described in detail herein.

While the terms vertical, horizontal, upper, lower, bottom, top and the like may be used herein, it is to be understood that these terms are used for ease in referencing the drawing and, unless otherwise indicated or required by context, does not denote a required orientation.

The different advantages and benefits provided by the present invention may be used individually or in combination with one, some or possibly even all of the other benefits. Furthermore, not every implementation, nor every component of an implementation, is necessarily required to obtain, or necessarily required to provide, one or more of the advantages and benefits of the implementation.

Conditional language, such as, among others, “can”, “could”, “might”, or “may”, unless specifically stated otherwise, or otherwise understood within the context as used, is generally intended to convey that certain embodiments optionally include certain features, elements and/or steps, while some other embodiments optionally do not include those certain features, elements and/or steps. Thus, such conditional language indicates, in general, that those features, elements and/or step are not required for every implementation or embodiment.

From the above, it will be appreciated that the robotic gantry described herein addresses several problems such as, but not limited to, reducing the human labor required to plant, grow, and harvest crops, farming with the use of harmful or potentially harmful chemicals, controlling the environment of the crops, and managing pests and bugs, in a manner and to a degree that was neither possible not practical before now.

Although the subject matter presented herein has been described in language specific to mechanical, operational, and computer structural features, and specific operations, it is to be understood that the appended claims are not necessarily limited to the specific hardware, features, acts, or media described herein. Furthermore, the claimed subject matter is not limited to implementations that solve any or all disadvantages noted in any part of this disclosure. Rather, the specific mechanical, operational, and computer structural features, and specific operations, are disclosed as example forms of implementing the claims and should not be construed as limiting. Various modifications and changes may therefore be made to the subject matter described herein and still fall within the scope of the claims.

1. A soil heating apparatus comprising:
a frame configured to be detachably mounted to a support structure or a moveable gantry, the frame movable in a vertical direction relative to the support structure;
an exhaust hood disposed in combination with the frame and having a shield directing heat downwardly toward a soil material to be heat treated;
a plurality of plates each pate haying an end portion projecting downwardly from the exhaust hood toward the soil material and configured to be lowered into the soil material by the frame at a predefined depth relative to the ground plane of the soil material; and
a burner disposed in combination with the exhaust hood and in fluid communication with a first supply of fuel and oxidizer, the burner configured to combust the first supply of fuel and oxidizer to heat each of the plates;
wherein the burner heats simultaneously heat the plurality of plates and the sold material at the predefined depth to thermally heat-treat the soil material.

2. The soil heating apparatus of claim 1, wherein the burner is disposed in combination with the exhaust hood and in fluid communication with a second supply of fuel and oxidizer, the burner configured to combust the second supply of fuel and oxidizer and project a high temperature flame toward the plane of the soil material and burn plant detritus in the soil material.

3. The soil heating apparatus of claim 1, further comprising a heat exchanging manifold disposed under the exhaust hood for preheating the second supply of fuel and oxidizer.

4. The soil heating apparatus of claim 1, wherein the burner comprises a heat transfer manifold disposed in fluid communication with a mixture of the first supply of fuel and oxidizer, the manifold distributing the mixture to a plurality of nozzles disposed adjacent at least one plate for heat treating the soil material.

5. The soil heating apparatus of claim 4, wherein the burner comprises a heat transfer manifold disposed in fluid communication with a mixture of the second supply of fuel and oxidizer, the manifold distributing the mixture to at least one nozzle for directing a flame of beat toward the plane of the soil material to burn the plant detritus.

6. The soil heating apparatus of claim 1, farther comprising a blower disposed upstream of the burner for suppling the oxidizer.

7. The soil heating apparatus of claim 1, further comprising a blower disposed upstream of the burner for supplying oxidizer to the first and second supply of fuel.

8. The soil heating apparatus of claim 7, wherein the oxidizer comprises ambient air introduced by the blower.

9. The soil heating apparatus of claim 1, further comprising at least two linearly variable actuators mounting between the Panic and moveable gantry, the linearly variable actuators operable to vary the height a the plates relative to the plane of the soil material.

10. The seeding device of claim 1, further comprising at least three linearly variable actuators mounting between the frame and moveable gantry, the linearly variable actuators operable to vary the height and the planar orientation of the burner relative to the plane of the soil material.

11. A soil heating apparatus comprising:
a frame configured to be detachably mounted to a support structure of a moveable gantry, the frame movable in a vertical direction relative to the support structure;
an exhaust hood disposed in combination with the frame and having a shield directing heat downwardly toward a soil material to be heat treated;
a plurality of plates each an end portion projecting downwardly from the exhaust hood toward the soil material and configured to be lowered into the sod material by the frame at a predefined depth relative to the ground plane of the soil material; and
a burner disposed in combination with, the exhaust hood and in fluid communication with a first supply of fuel and oxidizer, the burner configured to combust the first supply of fuel and oxidizer to heat each of the plates;
the burner, furthermore, being disposed in fluid communication with a second supply of fuel and oxidizer, the burner configured to combust the second supply of fuel and oxidizer and project a high temperature flame toward the plane of the soil material and burn plant, detritus in the soil material;
wherein the plurality of plates are oriented along a direction of motion of the moveable gantry to transfer heat into the soil material at the predefined depth to thermally heat-treat the soil material.

12. A method for heating soil comprising the steps of:
detachably mounting a soil heating apparatus to a moveable support structure, the soil heating apparatus including a plurality of plates each having an end portion projecting downwardly toward the soil material and configured to be lowered into the soil material at a predefined depth relative to the round plane of the soil material; and
burning a fuel and oxidizer between the plurality of plates to beat each of the plates;
drawing the plurality of plates through a specific depth of soil to form a plurality of parallel grooves in the soil material; and
thermally treating the soil, by transferring heat from the plurality of plates to the soil.

13. The method of claim 12 further comprising the step of:
configuring the soil heating apparatus with a burner configured to heat the plurality of plates and a project a high temperature flame toward the plane of the soil material to burn plant detritus in the soil material.

14. The method of claim 13, further comprising the step of forcibly introducing the oxidizer into the burner by a blower.

15. The method of claim 14 further comprising the step of arranging the blower to introduce the oxidizer into a first and second burner section. 16, The soil heating apparatus of claim 1 wherein the moveable support structure is one of a moveable gantry, a robotic gantry, a tractor and moveable farm vehicle.

17. The method of claim 12 wherein the moveable support structure includes one of a moveable gantry, a robotic gantry, a tractor and moveable farm vehicle.
